(19) United States
(12) Patent Application Publication
(10) Pub. No.: US 2014/0256173 A1
(43) Pub. Date: Sep. 11, 2014

(54) CONNECTOR ASSEMBLY OF ELECTRONIC DEVICE

(71) Applicants: HON HAI PRECISION INDUSTRY CO., LTD., New Taipei (TW); HONG FU JIN PRECISION INDUSTRY (WuHan) Co., Ltd., Wuhan (CN)

(72) Inventors: JUAN WANG, Wuhan (CN); MING-HUI LUO, Wuhan (CN); SAN-YONG YANG, Wuhan (CN); HUI-MIN ZHOU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/084,820

(22) Filed: Nov. 20, 2013

(30) Foreign Application Priority Data
Mar. 7, 2013 (CN) 2013100715692

(51) Int. Cl. H01R 4/24

(52) U.S. Cl. CPC H01R 4/2491
USPC 439/389

(57) ABSTRACT

A connector assembly includes a first connector, at least one second connector, and a plurality of cables. The first connector includes a plurality of conducting member. A plurality of cables connects the first connector and the at least one second connector. Each of the plurality of cables includes a metal conductor and an insulator. An extending direction of the plurality of cables is substantially perpendicular to a plugging direction of the first connector. Each of the plurality of conduction blades pierces each insulator of the plurality of cables and conducts with the metal conductor of the plurality of cables.

### BACKGROUND

1. Technical Field

The present disclosure relates to connector assemblies, and more particularly to a connector assembly of an electronic device.

2. Description of Related Art

A conventional connector assembly includes a connector and a cable used in a computer for connecting a motherboard to power supplies, data storage devices, expansion cards or other peripheral units. The cable is electrically connected to the connector. The cable extends from a rear side of the connector and extends away from a connecting direction of the connector. However, when the connector is plugged to an electronic component with slim space, the cable will be bent aside or may interrupt the adjacent electronic component. There is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is an exploded, isometric view of a connector assembly in accordance with one embodiment.

FIG. 2 is a partially assembled view of the connector assembly of FIG. 1.

FIG. 3 is a front view of a base with a plurality of conducting members of the connector assembly of FIG. 2.

FIG. 4 is similar to FIG. 2, but a plurality of cables is connected to a first connector.

FIG. 5 is an assembled view of the connector assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

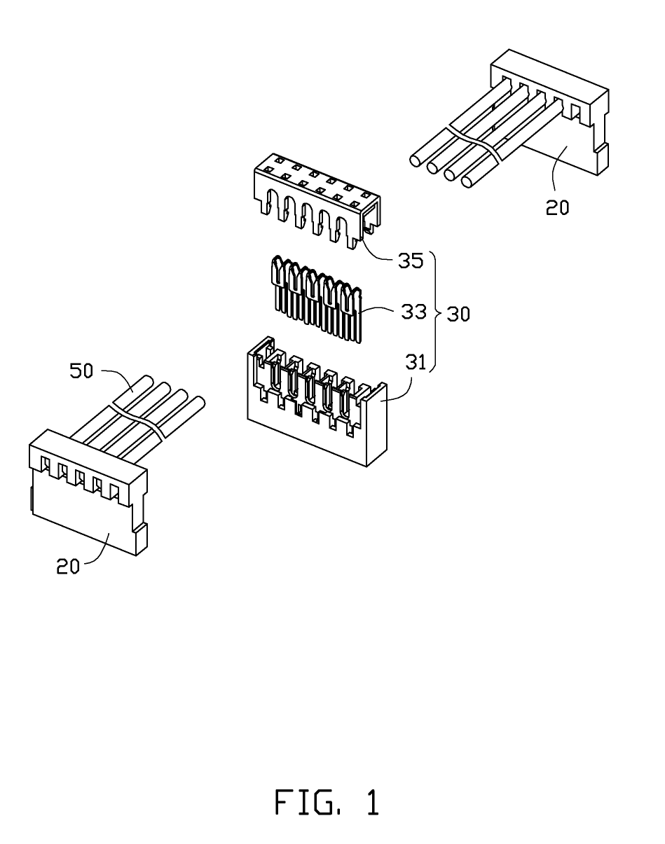

FIG. 1 illustrates an exploded view of a connector assembly in one embodiment. The connector assembly includes a first connector 30, two second connectors 20, and a plurality of cables 50. The plurality of cables 50 connects the first connector 30 to the two second connectors 20. The connector assembly can connect a data storage device, an expansion card, or peripheral devices to a motherboard. Each cable 50 includes two power supply cables and two grounding cables.

An extending direction of the plurality of cables 50 connecting the first connector 30 and the two second connectors 20 is substantially perpendicular to a first plugging direction of the first connector 30 and a second plugging direction of each second connector 20. The two second connectors 20 connect to the first connector 10 in similar the same way.

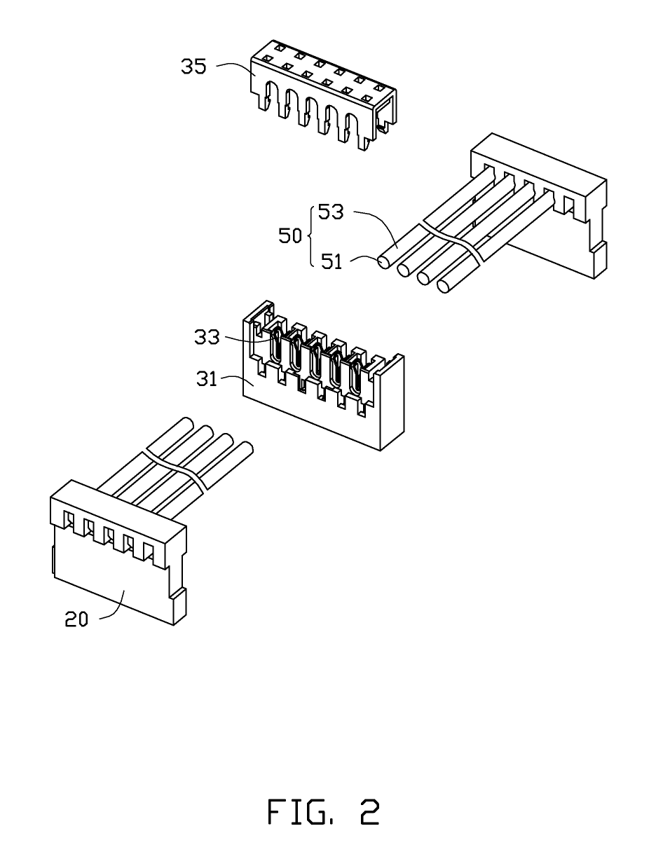

FIG. 2 illustrates the connector assembly similar to FIG. 1. Each cable 50 includes a metal conductor 51 and an insulator 53 covers on the metal conductor 51.

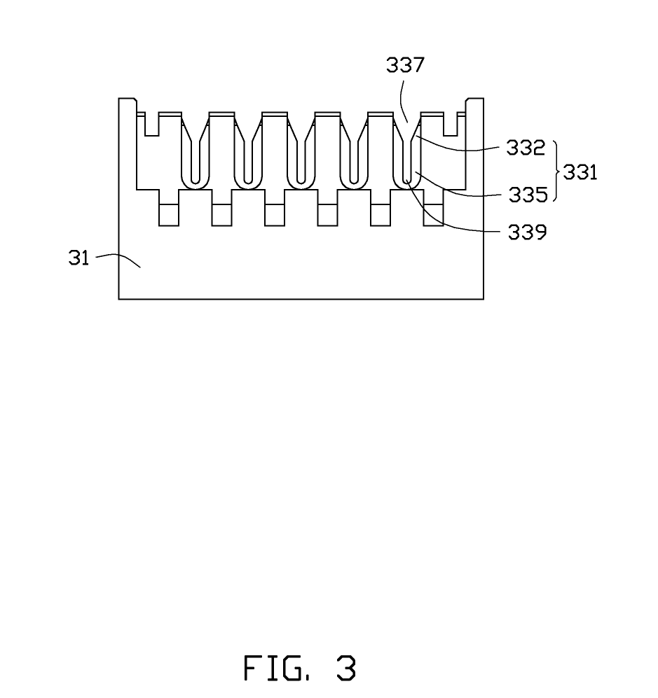

The first connector 30 includes a base 31, a plurality of conducting members 33, and a cover 35. The plurality of conducting members 33 is located in the base 31. FIG. 3 illustrates an assembled view of the base 31 and the plurality of conducting members 33. Each conducting members 33 includes two conducting blades 331. The two conducting blades 311 are substantially parallel to each other. Each conducting blade 311 includes a two cutting portions 332 and two conducting portions 335. The two cutting portions 332 extend down and are substantially oblique to each other so that when each cable 50 moves down to the cutting portions 332. The cutting portions 332 may cut the insulator 53 of each cable 50 and contact the metal conductor 51 of each cable 50. A cutting opening 337 is defined between the two cutting portions 332. The two conducting portions 335 are spaced and substantially parallel to each other. A distance between the two conducting portions 335 is not greater than a diameter of each metal conductor 51 of each cable 50. The two conducting portions 335 are connected to each other at bottom portions. A fixing recess 339 is defined in the bottom portions of the two conducting portions 335.

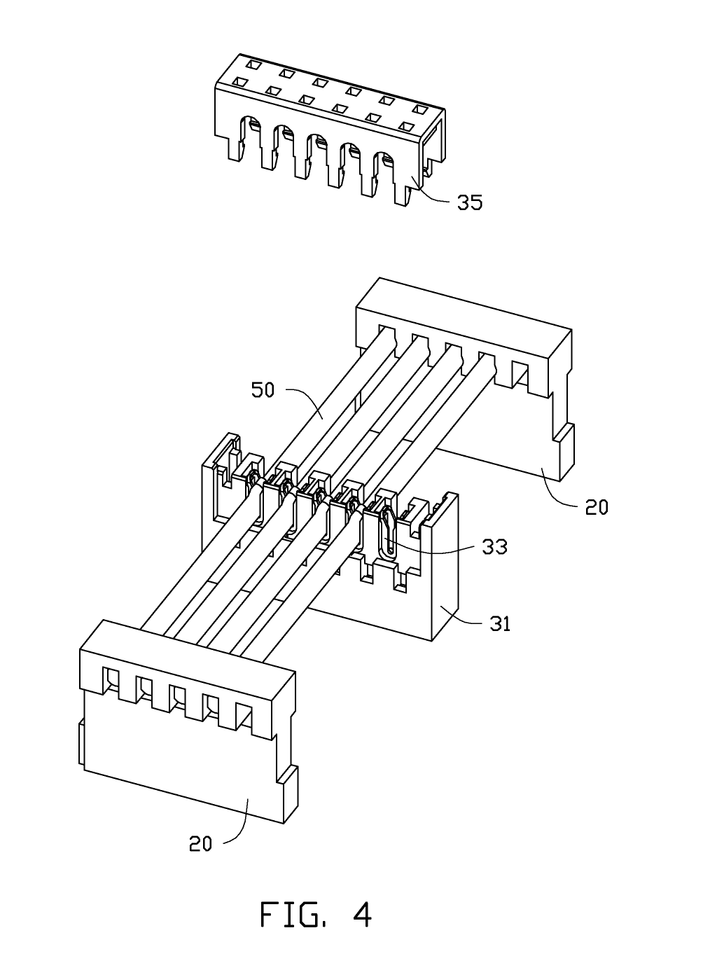

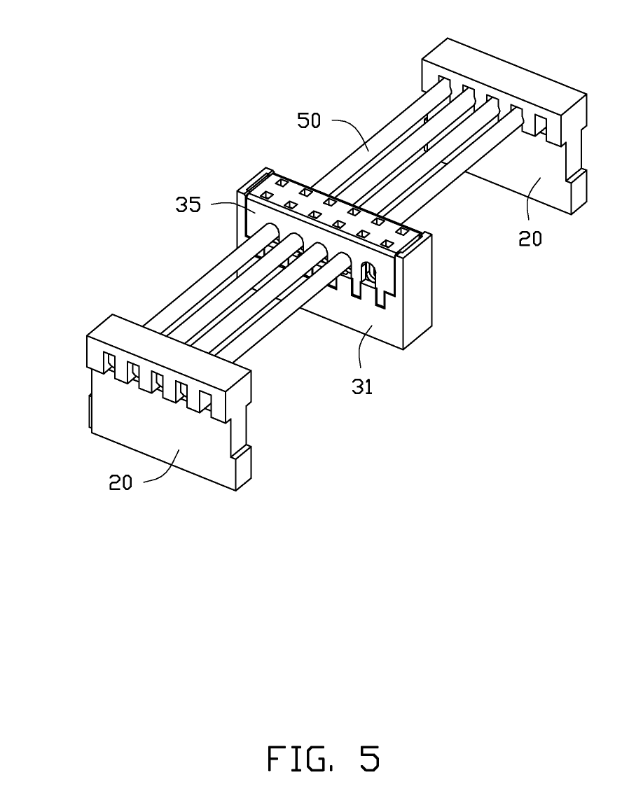

FIGS. 4 and 5 illustrate two assembled views of the connector assembly. In assembly, the plurality of conducting members 33 is mounted to the base 31. Each cable 50 moves down toward each conducting blade 331. The cutting portions 332 cut the insulator 53 of each cable 50 and contact the metal conductor 51 of each cable 50. The cable 50 is further moved down to the conducting portions 335. The conducting portions 335 of the cable 50 electronically contact the metal conductor 51. The cables 50 extend to opposite sides of the first connector 30. The two second connectors 20 are connected to the cables 50 and are located on the opposite sides of the first connector 30.

The cables 50 extend from lateral sides of the first connector 30, so that the connector assembly may not interrupt an electronic component on rear side of the first connector 30.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A connector assembly comprising:
a first connector comprising a plurality of conducting members; and
at least one second connector; and
a plurality of cables connecting the first connector and the at least one second connector, each of the plurality of cables comprising a metal conductor and an insulator, and an extending direction of the plurality of cables being substantially perpendicular to a plugging direction of the first connector;
wherein each of the plurality of conduction members is configured to pierce each insulator of the plurality of cables and conduct with the metal conductor of the plurality of cables.

2. The connector assembly of claim 1, wherein the at least one second connector comprises two second connectors, and the two second connectors are located on opposite sides of the first connector.

3. The connector assembly of claim 1, wherein the plurality of cables comprises two power supply cables and two grounding cables.

4. The connector assembly of claim 1, wherein each of the plurality of conducting members comprises two conducting blades, and the two conducting blades are substantially parallel to each other and configured to receive two of the plurality of cables from two opposite sides of the first connector.

5. The connector assembly of claim 4, wherein each of the plurality of conducting members comprises two cutting portions connected to each other, and the two cutting portions are oblique to each other.

6. The connector assembly of claim 5, wherein each of the plurality of conducting members further comprises two conducting portions connected to the two cutting portions, and the two conducting portions are spaced from and substantially parallel to each other.

7. The connector assembly of claim 6, wherein a distance between the two conducting portions is not greater than a diameter of the metal conductor of each of the plurality of cables.

8. The connector assembly of claim 1, wherein the first connector comprises a cover and a base, the plurality of conducting members is located in the base, and the cover engages with the base.

9. A connector assembly comprising:
a first connector comprising a plurality of conducting member; and
two second connectors; and
a plurality of cables connecting the first connector and the two second connectors, each of the plurality of cables comprising a metal conductor and an insulator, and the two second connectors being connected to the first connector from substantially opposite sides of the first connector;
wherein each of the plurality of conduction members is configured to pierce each insulator of the plurality of cables and conduct with each metal conductor of the plurality of cables.

10. The connector assembly of claim 9, wherein the plurality of cables comprises two power supply cables and two grounding cables.

11. The connector assembly of claim 9, wherein each of the plurality of conducting members comprises two conducting blades, and the two conducting blades are substantially parallel and configured to receive two of the plurality of cables from two opposite sides of the first connector.

12. The connector assembly of claim 11, wherein each of the plurality of conducting blades comprises two cutting portions, and the two cutting portions extend and are oblique to each other.

13. The connector assembly of claim 12, wherein each of the plurality of conducting blades further comprises two conducting portions connected to the two cutting portions, and the two conducting portions are spaced from and substantially parallel to each other.

14. The connector assembly of claim 13, wherein a distance between the two conducting portions is not greater than a diameter of the metal conductor of each of the plurality of cables.

15. The connector assembly of claim 9, wherein the first connector comprises a cover and a base, the plurality of conducting members is located in the base, and the cover engages with the base.
